(19) United States
(12) Patent Application Publication
(10) Pub. No.: US 2010/0302769 A1
(43) Pub. Date: Dec. 2, 2010

(54) LAMP

(76) Inventors: Alex HORNG, Kaohsiung (TW); Masaharu Miyahara, Kaohsiung (TW); Ssu-Hao Lai, Kaohsiung (TW)

Correspondence Address: Muncy, Geissler, Olds & Lowe, PLLC, 4000 Legato Road, Suite 310, FAIRFAX, VA, 22033, US

(21) Appl. No.: 12/473,522

(22) Filed: May 28, 2009

(51) Int. Cl. F21V 29/02

(52) U.S. Cl. 362/218

(57) ABSTRACT

A lamp includes a substrate having first and second sides. At least one lighting element is mounted on the first side. An air-guiding member is mounted to the substrate. An airflow chamber is formed between the air-guiding member and the second side of the substrate. The air-guiding member includes a plurality of air-guiding holes in communication with the air-guiding chamber. A plurality of heat-dissipating fans is respectively mounted to the air-guiding holes. A control unit is electrically connected to the heat-dissipating fans. The control unit controls operation timing and operation modes of the heat-dissipating fans so that the lamp has a plurality of heat-dissipating modes.

### BACKGROUND OF THE INVENTION

1. Field of the Invention

The present invention relates to a lamp and, more particularly, to a lamp capable of controlling operation timing and operation modes of a plurality of heat-dissipating fans to provide a plurality of heat-dissipating modes.

2. Description of the Related Art

Conventional lamps with heat-dissipating function include a body having a plurality of light-emitted diodes and a shade. The body further includes a plurality of fins for rapidly dissipating heat generated by the light-emitted diodes during operation. An example of such lamps is disclosed in Taiwan Utility Model No. M339636. However, the heat is accumulated at the fins, adversely affecting the overall heat-dissipating effect and shortening the service life of the lamp.

FIG. 1 shows a conventional lamp 9 including a substrate 91. A plurality of light-emitted diodes 911 is mounted on a side of the substrate 91. A fin 92 is mounted to the other side of the substrate 91. A heat-dissipating fan 93 is mounted to an end 921 of the substrate 91 for rapidly absorbing the heat generated by the light-emitted diodes 911 during operation. At the same time, the heat-dissipating fan 93 is activated to drive air currents through the fin 92 to allow rapid heat exchange between the fin and the air currents, enhancing the overall heat-dissipating effect. However, the heat-dissipating effect is good in the area at the first end 921 of the fin 92 but poor at the other end 922 of the fin 92 distant to the heat-dissipating fan 93. Furthermore, dust is liable to accumulate at the fin 92 and, thus, adversely affect the heat-dissipating effect. Further, the heat-dissipating fan 93 will be damaged after a long period of time of operation. Further, the heat-dissipating fan 93 could not effectively lower the temperature of the light-emitted diodes 911 when the light-emitted diodes 911 overheat. Overall, the heat-dissipating effect of the heat-dissipating fan 93 is unsatisfactory, and the service life of the lamp 9 can not be further prolonged.

In an approach to enhance the overall heat-dissipating effect of the lamp 9, more heat-dissipating fans 93 are mounted on the fin 92 and operate simultaneously. However, the problems of damage to the heat-dissipating fans 93 resulting from long-term, simultaneous operation and of accumulation of dust adverse affecting the heat-dissipating effect still exist.

### SUMMARY OF THE INVENTION

The primary objective of the present invention is to provide a lamp having an enhanced heat-dissipating effect.

Another objective of the present invention is to provide a lamp capable of providing the same heat-dissipating effect without long-term operation of every heat-dissipating fan.

A further objective of the present invention is to provide a lamp with dust-cleaning function.

In a first aspect, a lamp according to the preferred teachings of the present invention includes a substrate having first and second sides. At least one lighting element is mounted on the first side. An air-guiding member is mounted to the substrate. An airflow chamber is formed between the air-guiding member and the second side of the substrate. The air-guiding member includes a plurality of air-guiding holes in communication with the air-guiding chamber. A plurality of heat-dissipating fans is respectively mounted to the air-guiding holes. A control unit is electrically connected to the heat-dissipating fans. The control unit controls operation timing and operation modes of the heat-dissipating fans so that the lamp has a plurality of heat-dissipating modes.

Preferably, the air-guiding member includes at least one opening in communication with the airflow chamber.

Preferably, the air-guiding member includes two air-guiding holes formed in two opposite ends thereof, and the lamp includes two heat-dissipating fans.

Preferably, the air-guiding member includes a plurality of fins in the airflow chamber.

Preferably, the control unit includes a power supply and a control circuit electrically connecting to the power supply, while the control circuit also electrically connects with the heat-dissipating fans respectively. The control circuit can be mounted in one of the heat-dissipating fans.

Preferably, the air-guiding member includes a housing including a top plate having four sides. The air-guiding member further includes four side plates respectively mounted to the four sides of the top plate. The airflow chamber is formed between the top plate and the second side of the substrate. The air-guiding holes are formed in the top plate.

Preferably, the substrate includes a temperature sensor electrically connected to the control unit for sensing temperature of the at least one lighting element.

In a second aspect, a lamp according to the preferred teachings of the present invention includes a substrate having first and second sides. At least one lighting element is mounted on the first side. An air-guiding member is mounted to the substrate. A plurality of heat-dissipating fans is mounted to the air-guiding member. A control unit is electrically connected to the heat-dissipating fans. The control unit controls operation timing and operation modes of the heat-dissipating fans so that the lamp has a plurality of heat-dissipating modes.

Preferably, the air-guiding member includes a heat dissipater having a plurality of fins. Each fin has first and second ends. An airflow chamber is formed between two adjacent fins. The heat-dissipating fans are respectively mounted across the first ends and the second ends of the fins.

The present invention will become clearer in light of the following detailed description of illustrative embodiments of this invention described in connection with the drawings.

### BRIEF DESCRIPTION OF THE DRAWINGS

The illustrative embodiments may best be described by reference to the accompanying drawings where:

FIG. 1 shows a cross sectional view of a conventional lamp.

FIG. 2 shows an exploded, perspective view of a lamp of an embodiment according to the preferred teachings of the present invention.

FIG. 3 shows a cross sectional view of the lamp of FIG. 2 with one of two heat-dissipating fans in an operative state and with the other heat-dissipating fan in an inoperative state.

FIG. 4 shows a cross sectional view of the lamp of FIG. 2 with the heat-dissipating fan in an inoperative state and with the other heat-dissipating fan in an operative state.

FIG. 5 shows a cross sectional view of the lamp of FIG. 2 with an air-guiding member modified and with the lamp in a different operation mode.

FIG. 6 shows a cross sectional view of the lamp of FIG. 2 with the lamp in a dust-cleaning mode.

FIG. 7 shows an exploded, perspective view of a lamp of another embodiment according to the preferred teachings of the present invention.

FIG. 8 shows a schematic block diagram of an example of a control unit of the lamp according to the preferred teachings of the present invention.

FIG. 9 shows a schematic block diagram of another example of the control unit of the lamp according to the preferred teachings of the present invention.

FIG. 10 shows an exploded, perspective view of a lamp of a further embodiment according to the preferred teachings of the present invention.

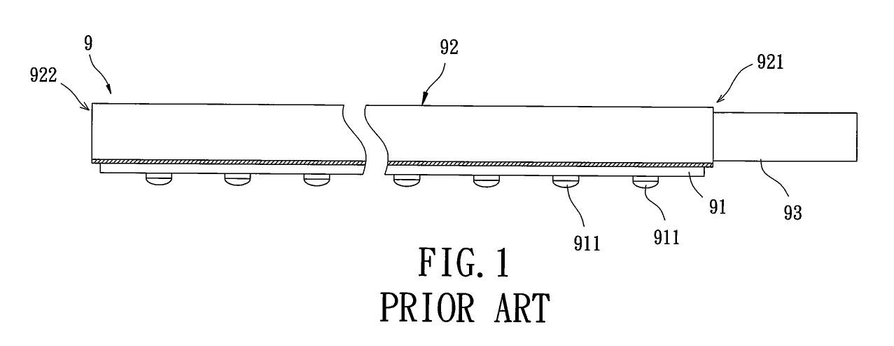

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “first”, “second”, “end”, “side”, “portion”, and similar terms are used herein, it should be understood that these terms have reference only to the structure shown in the drawings as it would appear to a person viewing the drawings and are utilized only to facilitate describing the invention.

### DETAILED DESCRIPTION OF THE INVENTION

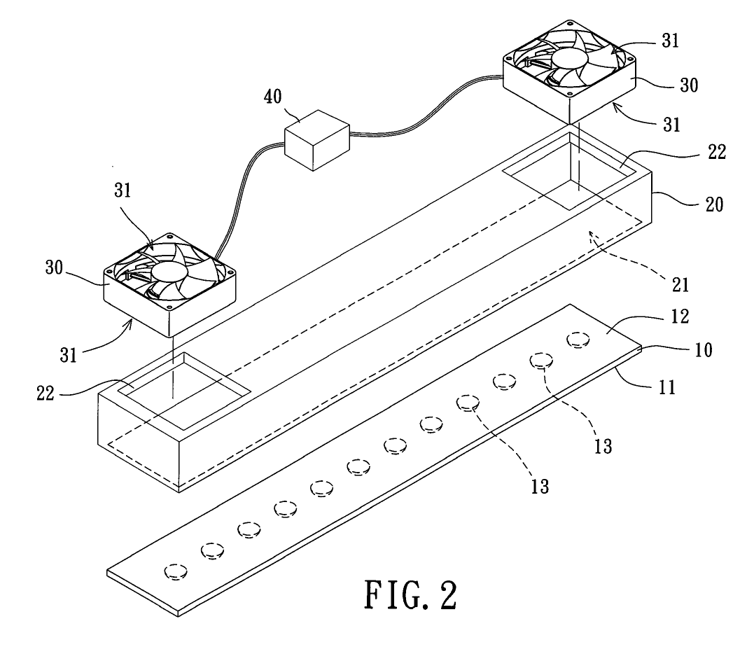

A lamp of an embodiment according to the preferred teachings of the present invention is shown in FIG. 2. In this embodiment, the lamp includes a substrate 10, an air-guiding member 20, a plurality of heat-dissipating fans 30, and a control unit 40. The substrate 10 includes opposite first and second sides 11 and 12. A plurality of lighting elements 13 is mounted on the first side 11 of the substrate 10. Each lighting elements 13 can be a light-emitted diodes, a light bulb, or any element capable of providing illuminating function. It can be appreciated that the substrate 10 can include only one lighting element 13.

The air-guiding member 20 is preferably made of heat-conducting material. The air-guiding member 20 is a housing in the preferred form shown in FIG. 2 and includes a top plate and four side plates mounted to four sides of the top plate. The air-guiding member 20 is mounted to the substrate 10 so that the air-guiding member 20 and the second side 12 of the substrate 10 together define an airflow chamber 21. The air-guiding member 20 includes two air-guiding holes 22 in communication with the airflow chamber 21. In the preferred form shown in FIG. 2, the air-guiding holes 22 are formed in opposite ends of the top plate of the air-guiding member 20, providing a larger airflow chamber 21.

The heat-dissipating fans 30 can be of blower type or axial flow type. In the preferred form shown in FIG. 2, the lamp includes two heat-dissipating fans 30 of axial type and respectively mounted to the air-guiding holes 22. Furthermore, each heat-dissipating fan 30 includes two air-guiding portions 31 respectively serving as an air inlet and an air outlet. Each of the heat-dissipating fans 30 is mounted to one of the air-guiding holes 22 with the air-guiding portion 31 serving as the air inlet facing the airflow chamber 21 and with the air-guiding portion 31 serving as the air outlet facing the environment. In accordance with the need, numbers of the air-guiding holes 22 and the heat-dissipating fans 30 can be selected as more than two.

The control unit 40 is electrically connected to the heat-dissipating fans 30 for controlling operation timing and operation modes of each heat-dissipating fan 30 according to various conditions, providing various heat-dissipating modes.

In use, the lighting elements 13 of the substrate 10 emit light beams and generate heat that is transferred to the airflow chamber 21 of the air-guiding member 20. The heat-dissipating fans 30 are activated to drive the air currents into the airflow chamber 21 for heat exchange purposes. After heat exchange, the air currents are driven out of the airflow chamber 21 into the environment to achieve a heat-dissipating effect.

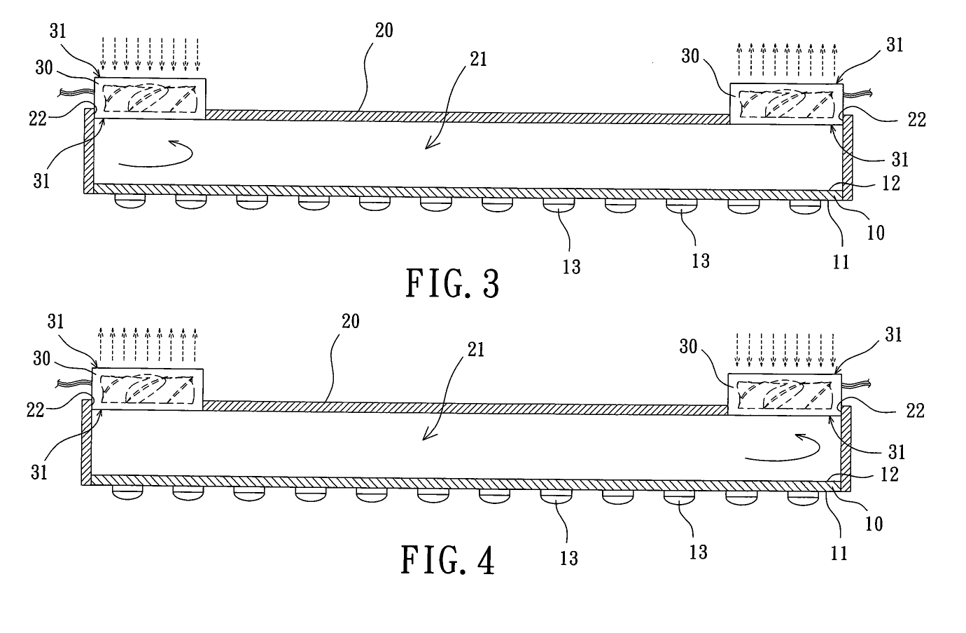

The heat-dissipating modes and advantages thereof provided by the control unit 40 and the heat-dissipating fans 30 will now be described. When the lighting elements 13 do not overheat, the heat-dissipating fans 30 can be controlled by the control unit 40 to operate alternately to achieve the heat-dissipating effect. Since long-term operation of every heat-dissipating fan 30 is not required, the overall service life of the lamp according to the preferred teachings of the present invention is prolonged. Specifically, with reference to FIG. 3, one of the heat-dissipating fans 30 (the left one) operates under control of the control unit 40 while the other heat-dissipating fan 30 (the right one) is inoperative. After a period of time (which can be determined according to needs), the control unit 40 stops operation of the left heat-dissipating fan 30 and starts operation of the right operation fan 30, as shown in FIG. 4. Thus, the required heat-dissipating effect can still be obtained through alternate operation of the heat-dissipating fans 30 while avoiding damage to the lamp according to the preferred teachings of the present invention due to long-term operation of every heat-dissipating fan 30.

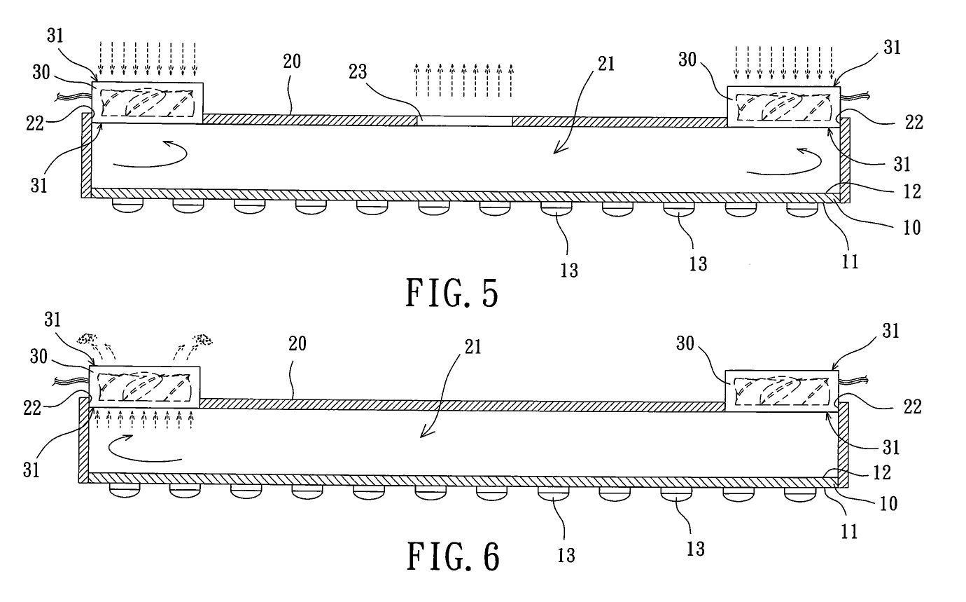

With reference to FIG. 5, when the lighting elements 13 on the substrate 10 overheat during operation, the control unit 40 can activate both heat-dissipating fans 30 to operate, providing an enhanced heat-dissipating effect to avoid damage to the lighting elements 13. Note that the air-guiding member 20 includes an opening 23 through which the air currents exit the airflow chamber 21. The opening 23 serves as an air outlet while the air-guiding portions 31 serve as air inlets when the heat-dissipating fans 30 operate, allowing smooth guiding for the airflow. It can be appreciated that the air-guiding member 20 can include more than one opening 23.

In a case that dust accumulates in the air-guiding holes 22, one of the heat-dissipating fans 30 (such as the left one in FIG. 6) can rotate in a reverse direction under control of the control unit 40 so that the air in the airflow chamber 21 can be driven out of the air-guiding member 20 through one of the air-guiding holes 22. Dust accumulated in the air-guiding holes 22 is, thus, removed. Reduced amount of wind resulting from blockage of the air-guiding holes 22 is, thus, avoided. The overall heat-dissipating effect is effectively enhanced, and the service life of the lamp according to the preferred teachings of the present invention. It can be appreciated that use of axial fans provides a better dust-cleaning effect.

In a case that one of the heat-dissipating fans 30 is damaged, the other heat-dissipating fan 30 can still operate under control of the control unit 40, assuring normal operation of the lamp according to the preferred teachings of the present invention.

It can be appreciated that since the heat-dissipating fans 30 are on opposite ends of the air-guiding members 20, the heat-dissipating effect provided for the lighting elements 13 is more uniform and more reliable when the heat-dissipating fans 30 operate simultaneously.

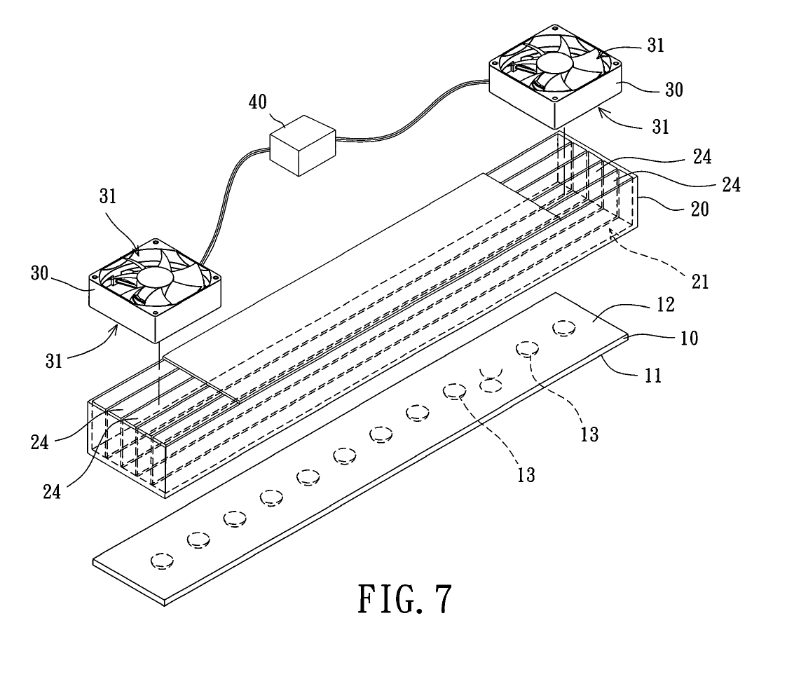

In a preferred form shown in FIG. 7, the air-guiding member 20 further includes a plurality of fins 24 in the airflow chamber 21. The heat generated during operation of the lighting elements 13 can be more effectively transferred into the airflow chamber 21, achieving an excellent heat-dissipating effect.

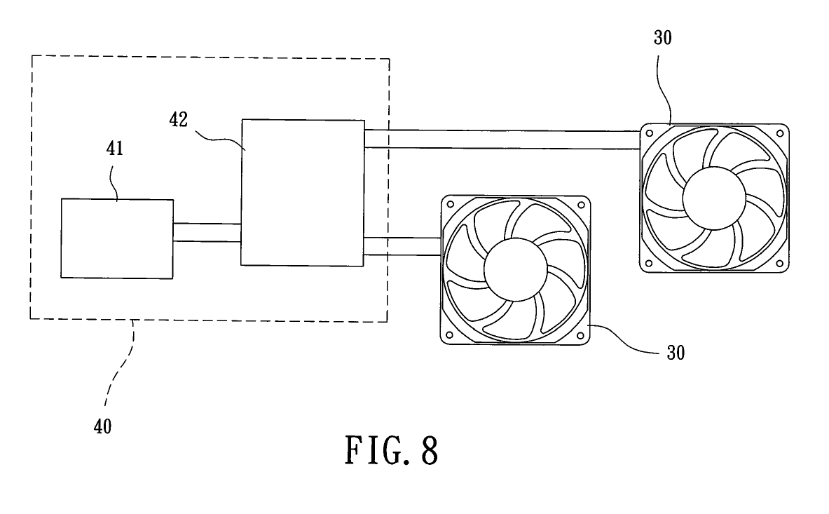

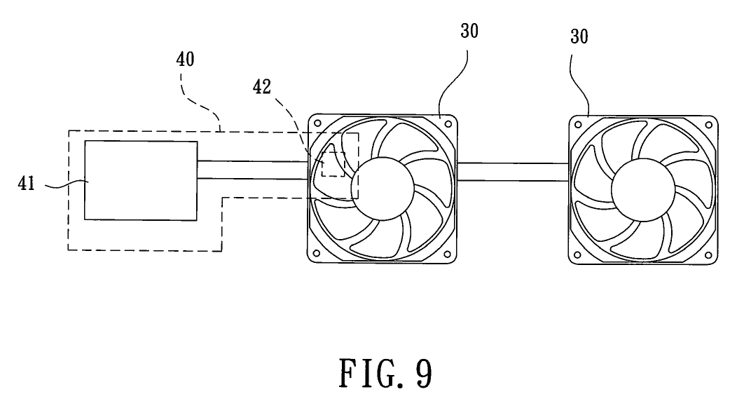

The control unit 40 includes a power supply 41 and a control circuit 42 electrically connected to the power supply 41 and the heat-dissipating fans 30. In a preferred form shown in FIG. 8, the control circuit 42 is outside of the heat-dissipating fans 30. In a preferred form shown in FIG. 9, the control circuit 42 is mounted in one of the heat-dissipating fans 30 to save space.

The substrate 10 can include a temperature sensor electrically connected to the control unit 40. The temperature of the lighting elements 13 can be sensed by the temperature sensor so that the control unit 40 can rapidly control each heat-dissipating fan 30 to provide more suitable heat-dissipating mechanisms.

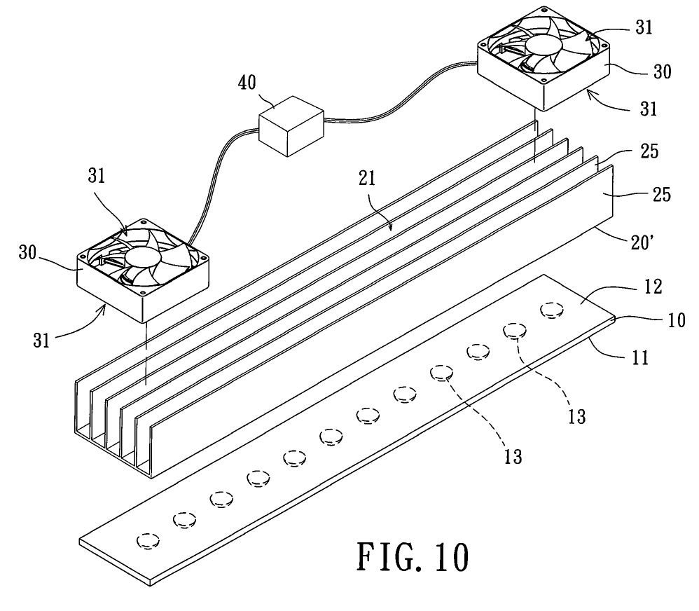

In a preferred form shown in FIG. 10, the air-guiding member 20′ is in the form of a heat dissipater including a plurality of fins 25 each having first and second ends. An air-guiding chamber 21 is defined between two adjacent fins 25. One of the heat-dissipating fans 30 is mounted across the first ends of the fins 25. The other heat-dissipating fan 30 is mounted across the second ends of the fins 25. By such an arrangement, the fins 25 can transfer the heat generated by the lighting elements 13 into the air-guiding chambers 21. Furthermore, the air currents are driven into the air-guiding chambers 21 to carry away the heat to the environment under operation of the heat-dissipating fans 30. The operation timing and operation modes of the heat-dissipating fans 30 can be controlled by the control unit 40 to provide a plurality of different heat-dissipating modes while having a simplified structure.

According to the above, the lamp according to the preferred teachings of the present invention provides a plurality of different heat-dissipating modes by utilizing the control unit 40 and the heat-dissipating fans 30. The heat-dissipating effect provided for the lighting elements 13 is enhanced and is more uniform, effectively prolonging the service life of the lamp according to the preferred teachings of the present invention.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. A lamp comprising:
a substrate including first and second sides, with at least one lighting element mounted on the first side;
an air-guiding member mounted to the substrate, with an airflow chamber formed between the air-guiding member and the second side of the substrate, with the air-guiding member including a plurality of air-guiding holes in communication with the air-guiding chamber;
a plurality of heat-dissipating fans respectively mounted to the plurality of air-guiding holes; and
a control unit electrically connected to the plurality of heat-dissipating fans, with the control unit controlling operation timing and operation modes of the plurality of heat-dissipating fans so that the lamp has a plurality of heat-dissipating modes.

2. The lamp as claimed in claim 1, with the air-guiding member including at least one opening in communication with the airflow chamber.

3. The lamp as claimed in claim 1, with the plurality of air-guiding holes including two air-guiding holes, with the plurality of heat-dissipating fans including two heat-dissipating fans, and with the two air-guiding holes formed in two opposite ends of the air-guiding member.

4. The lamp as claimed in claim 3, with the air-guiding member including a plurality of fins in the airflow chamber.

5. The lamp as claimed in claim 1, with the air-guiding member including a plurality of fins in the airflow chamber.

6. The lamp as claimed in claim 1, with the control unit including a power supply and a control circuit, and with the control circuit electrically connected to the power supply and to the plurality of heat-dissipating fans respectively.

7. The lamp as claimed in claim 6, with the control circuit mounted in one of the plurality of heat-dissipating fans.

8. The lamp as claimed in claim 1, with the air-guiding member including a housing including a top plate having four sides, with the air-guiding member further including four side plates respectively mounted to the four sides of the top plate, with the airflow chamber formed between the top plate and the second side of the substrate, and with the plurality of air-guiding holes formed in the top plate.

9. The lamp as claimed in claim 1, with the substrate including a temperature sensor electrically connected to the control unit, and with the temperature sensor sensing temperature of said at least one lighting element.

10. A lamp comprising:
a substrate including first and second sides, with at least one lighting element mounted on the first side;
an air-guiding member mounted to the second side of the substrate;
a plurality of heat-dissipating fans mounted to the air-guiding member; and
a control unit electrically connected to the plurality of heat-dissipating fans, with the control unit controlling operation timing and operation modes of the plurality of heat-dissipating fans so that the lamp has a plurality of heat-dissipating modes.

11. The lamp as claimed in claim 10, with the air-guiding member including a heat dissipater having a plurality of fins, with each of the plurality of fins having first and second ends, with an airflow chamber formed between two of the plurality of fins adjacent to each other, with the plurality of heat-dissipating fans respectively mounted across the first ends and the second ends of the plurality of fins.
